(19) United States
(12) Patent Application Publication
(10) Pub. No.: US 2026/0361628 A1
(43) Pub. Date: Nov. 12, 2026

(54) INTER-NODE COORDINATION FOR RADIO ACCESS NETWORK VISIBLE QUALITY OF EXPERIENCE REPORTING IN DUAL CONNECTIVITY

(71) Applicant: Telefonaktiebolaget LM Ericsson (publ), Stockholm (SE)

(72) Inventors: Filip BARAC, Huddinge (SE); Ali PARICHEHREHTEROUJENI, Linköping (SE); Luca LUNARDI, Genoa (IT); Cecilia EKLÖF, Täby (SE); Johan RUNE, Lidingö (SE)

(21) Appl. No.: 19/099,319

(22) PCT Filed: Aug. 7, 2023
(86) PCT No.: PCT/SE2023/050783

§ 371 Date: Jan. 28, 2025

Related U.S. Application Data
(60) Provisional application No. 63/396,043, filed on Aug. 8, 2022.

(51) Int. Cl. H04L 43/065; H04L 69/322

(52) U.S. Cl. CPC H04L 43/065; H04L 69/322

(57) ABSTRACT

A method, system and apparatus are disclosed. a method in a first network node configured to communicate with a user equipment (UE) and a second network node is described. At least the UE is configurable to communicate using multi-radio connectivity with the first network node and the second network node. The method includes coordinating with the second network node to determine which one of the first network node and the second network node has a report corresponding to a service type associated with the UE. In addition, the method includes determining which one of the first network node and the second network node carries data for an application session subject to quality of experience measurements associated with the report and performing one or more actions to ensure that one of the first network node and the second network node which carries the data obtains the report.

### TECHNICAL FIELD

The present disclosure relates to wireless communications, and in particular, to inter-node coordination for reporting in multi-node connectivity environments.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile user equipment (UEs) (which may be referred to as wireless devices (WDs), as well as communication between network nodes and between UEs. The 3GPP is also developing standards for Sixth Generation (6G) wireless communication systems.

Further, wireless communication systems such as 5G and 6G systems may comprise at least one radio access network (RAN) and/or one or more RAN network nodes. FIG. 1 shows an example overall architecture of next generation RAN (NG-RAN). The NG-RAN includes of a set of gNBs (i.e., network nodes) connected to a 5G core (5GC) through an NG interface.

NOTE: NG-RAN, e.g., as specified in 3GPP technical specification (TS) 38.300 v17.1.0, may also include a set of next generation eNodeBs (ng-eNBs). An ng-eNB may include an ng-eNB centralized unit (NG-eNB-CU) and one or more ng-eNB distributed units (ng-eNB-DU(s)). An ng-eNB-CU and an ng-eNB-DU may be connected via a W1 interface. The general principle described herein may also apply to ng-eNB and W1 interface, e.g., if not explicitly specified otherwise. An gNB can support frequency division duplex (FDD) mode, time division duplex (TDD) mode, or dual mode operation. Further, gNBs can be interconnected through the Xn interface.

Also, a gNB may include of a gNB-CU and one or more gNB-DU(s). A gNB-CU and a gNB-DU may be connected via F1 interface. One gNB-DU may be connected to one gNB-CU.

NOTE: In case of network sharing with multiple cell ID broadcast, each Cell Identity associated with a subset of PLMNs corresponds to a gNB-DU and the gNB-CU it is connected to, i.e., the corresponding gNB-DUs share the same physical layer cell resources.

NOTE: For resiliency, a gNB-DU may be connected to multiple gNB-CUs by appropriate implementation.

### NG, Xn and F1 May be Logical Interfaces

For NG-RAN, the NG and Xn-C interfaces for a gNB consisting of a gNB-CU and gNB-DUs, terminate in the gNB-CU. For Dual connectivity between E-UTRA and NR (EN-DC), the S1-U and X2-C interfaces for a gNB consisting of a gNB-CU and gNB-DUs, terminate in the gNB-CU. The gNB-CU and connected gNB-DUs are visible, e.g., only visible, to other gNBs and the 5GC as a gNB.

The node hosting user plane part of NR PDCP (e.g., gNB-CU, gNB-CU user plane (UP), and for EN-DC, Master eNB (MeNB) or Secondary gNB (SgNB) depending on the bearer split) may perform user inactivity monitoring and further informs its inactivity or (re) activation to the node having C-plane connection towards the core network (e.g., over E1, X2). The node hosting NR RLC (e.g., gNB-DU) may perform user inactivity monitoring and further inform its inactivity or (re) activation to the node hosting control plane, e.g., gNB-CU or gNB-CU control plane (CP).

Uplink (UL) packet data control protocol (PDCP) configuration (i.e., how the UE uses the UL at the assisting node) is indicated via X2-C (for EN-DC), Xn-C (for NG-RAN) and F1-C. Radio Link Outage/Resume for downlink (DL) and/or UL is indicated via X2-U (for EN-DC), Xn-U (for NG-RAN) and F1-U. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related transport network layer (TNL) protocol and the functionality are specified. The TNL provides services for user plane transport, signalling transport.

In NG-Flex configuration, each NG-RAN node may be connected to all access and mobility functions (AMFs) of AMF Sets within an AMF Region supporting at least one slice also supported by the NG-RAN node. The AMF Set and the AMF Region may be those defined in 3GPP TS 23.501 v17.5.0. If security protection for control plane and user plane data on TNL of NG-RAN interfaces has to be supported, network domain security/internet protocol (NDS/IP) 3GPP TS 33.501 v17.6.0 may be applied.

Overall Architecture for Separation of gNB-CU-CP and gNB-CU-UP

An overall architecture for separation of gNB-CU-CP and gNB-CU-UP is shown in the example of FIG. 2 and may be the overall architecture specified in 3GPP TS 37.483. As described above, a gNB may include a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP.

NOTE 1: For resiliency, a gNB-DU and/or a gNB-CU-UP may be connected to multiple gNB-CU-CPs by appropriate implementation.

One gNB-DU can be connected to multiple gNB-CU-UPs under the control of the same gNB-CU-CP. One gNB-CU-UP can be connected to multiple DUs under the control of the same gNB-CU-CP.

NOTE 2: The connectivity between a gNB-CU-UP and a gNB-DU is established by the gNB-CU-CP using Bearer Context Management functions.

NOTE 3: The gNB-CU-CP selects the appropriate gNB-CU-UP(s) for the requested services for the UE. In case of multiple CU-UPs they belong to same security domain as defined in 3GPP TS 33.210 v17.0.0.

NOTE 4: Data forwarding between gNB-CU-UPs during intra-gNB-CU-CP handover within a gNB may be supported by Xn-U.

### Dual Connectivity

In dual connectivity (DC), a UE capable of multiple transmission/receptions, may be connected to more than one RAN node. The RAN nodes may be of the same radio access technology (RAT) (both master node and secondary node in NR or LTE respectively) or different RATs, e.g., one master LTE node and one secondary NR node. In specification 3GPP TS 37.340 v17.1.0, the principles of multi-radio dual connectivity are described.

Start of Excerpt from 3GPP TS 37.340

### General

Common MR-DC principles

Multi-Radio Dual Connectivity (MR-DC) is a generalization of the Intra-E-UTRA Dual Connectivity (DC) described in 3GPP TS 36.300, where a multiple Rx/Tx capable UE may be configured to utilise resources provided by two different nodes connected via non-ideal backhaul, one providing NR access and the other one providing either E-UTRA or NR access. One node acts as the master node (MN) and the other as the secondary node (SN). The MN and SN are connected via a network interface and at least the MN is connected to the core network.

The MN and/or the SN can be operated with shared spectrum channel access.

All functions specified for a UE may be used for an IAB-MT unless otherwise stated. Similar as specified for UE, the LAB-MT can access the network using either one network node or using two different nodes with EN-DC and NR-DC architectures. In EN-DC, the backhauling traffic over the E-UTRA radio interface is not supported.
NOTE 1: MR-DC is designed based on the assumption of non-ideal backhaul between the different nodes but can also be used in case of ideal backhaul.
NOTE 2: All MR-DC normative text and procedures in this version of the specification show the aggregated node case. The details about non-aggregated node for MR-DC operation are described in 3GPP TS 38.401.
   MR-DC with the EPC

E-UTRAN supports MR-DC via E-UTRA-NR Dual Connectivity (EN-DC), in which a UE is connected to one eNB that acts as a MN and one en-gNB that acts as a SN. The eNB is connected to the EPC via the S1 interface and to the en-gNB via the X2 interface. The en-gNB might also be connected to the EPC via the S1-U interface and other en-gNBs via the X2-U interface. An example EN-DC overall architecture is shown in FIG. 3.

MR-DC with the 5GC
E-UTRA-NR Dual Connectivity NG-RAN supports NG-RAN E-UTRA-NR Dual Connectivity (NGEN-DC), in which a UE is connected to one ng-eNB that acts as a MN and one gNB that acts as a SN.

### NR-E-UTRA Dual Connectivity

NG-RAN supports NR-E-UTRA Dual Connectivity (NE-DC), in which a UE is connected to one gNB that acts as a MN and one ng-eNB that acts as a SN.

### NR-NR Dual Connectivity

NG-RAN supports NR-NR Dual Connectivity (NR-DC), in which a UE is connected to one gNB that acts as a MN and another gNB that acts as a SN. In addition, NR-DC can also be used when a UE is connected to two gNB-DUs, one serving the MCG and the other serving the SCG, connected to the same gNB-CU, acting both as a MN and as a SN.

End of Excerpt from 3GPP TS 37.340

One or more flows for setting up dual connectivity may be the flows described in chapter 10 of 3GPP TS 37.340, which is shown in FIG. 4, i.e., a second node addition procedure.

### Overview of the QOE Framework

### “Regular” QoE

Quality of Experience (QoE) measurements, also referred to as “application layer measurements”, have been specified for LTE and UMTS and are being specified for NR in 3GPP Release 17 (Rel-17). The purpose of the application layer measurements is to measure the end user experience when using certain applications. Currently QoE measurements for streaming services and for mobility telephony service for internet protocol based media system (MTSI) services are supported. For NR, it is likely that at least VR is added to the list of services for which QoE measurements are specified and supported.

The solutions in LTE and UMTS are similar with the overall principles as follows. Quality of Experience Measurement Collection (QMC) enables configuration of application layer measurements in the UE and transmission of QoE measurement result files (commonly referred to as QoE reports) to the network by means of RRC signaling. An application layer measurement configuration (also called QoE measurement configuration or QoE configuration) that the RAN receives from the operating and maintenance (OAM) system or the CN is encapsulated in a transparent container, which is forwarded to a UE in a downlink radio resource control (RRC) message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP Rel-17, a new study item for “Study on NR QoE management and optimizations for diverse services” for NR was undertaken. The specification work for 3GPP Rel-17 is still ongoing. The purpose of the study item is to study solutions for QoE measurements in NR. QoE management in NR will not just collect the quality of experience parameters of streaming services but also consider the typical performance requirements of diverse services (e.g., augmented reality/virtual reality (AR/VR) and ultra reliable and low latency communications (URLLC), of which at least VR seems to be covered in 3GPP Rel-17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (i.e. the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE, e.g., WD, and are placed in a “container” which the network entities handling it, e.g., forwarding it to the UE, as well as the UE Access Stratum, cannot interpret and do not try to read. The currently specified service types are MTSI and streaming service (DASH), and in 3GPP Rel-17, at least service type VR will be added. An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two flavors: management-based QoE configuration and signaling-based QoE configuration. In both cases the QoE configuration originates in the OAM system or some other administrational entity, e.g., dealing with customer satisfaction. All of these entities are in this document referred to as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the HSS (in EPS/LTE) or UDM (in 5GS/NR), which forwards the QoE configuration to the UE's current core network node (CN), e.g., an MME in EPS/LTE or an AMF in 5G/NR. The CN then forwards the s-based QoE configuration to the RAN node that serves the concerned UE, and the RAN forwards it to the UE.

The service type indication and the container with the measurement instructions are forwarded to the UE. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR and LTE, a globally unique QoE reference (formed of mobile country code (MCC)+mobile network code (MNC)+QMC ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing, and the UE Access Stratum is also not automatically aware of this. To alleviate this session start/stop indications can be introduced, which will be sent from the application layer in the UE to the UE AS and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE)

In NR, 3GPP Rel-17 introduced RAN visible QoE measurements. A general description can be found in 3GPP TS 38.300 v17.0.0 clause 21.4.

RAN visible QoE measurements are configured by the NG-RAN node, where a subset of QoE metrics is reported from the UE as an explicit information element (IE) readable by the NG-RAN node. RAN visible QoE measurements (e.g., RAN visible QoE metrics, RAN visible QoE values) could be utilized by the NG-RAN node for network optimization. RAN visible QoE measurements are supported for the DASH streaming and VR services. The NG-RAN node configures the RAN visible QoE measurement to collect all or some of the available RAN visible QoE metrics, where the indication of metric availability is received from the OAM or CN. The set of available RAN visible QoE metrics is a subset of the metrics which are already configured as part of QoE measurement configuration encapsulated in the transparent container. The packet data unit (PDU) session ID(s) corresponding to the service that is subject to QoE measurements can also be reported by the UE along with the RAN visible QoE measurement results.

A request for collecting QoE measurements not visible to RAN (also called OAM-QoE in R3-223290) is started from OAM and identified by a QoE Reference. A definition for this identifier can be found e.g., in 3GPP TS 28.405 v17.1.0, clause 5.2:
The QoE reference parameter specifies the network request session. The QoE reference shall be globally unique therefore it is composed as follows:
   MCC+MNC+QMC ID, where the MCC and MNC are coming with the QMC activation request from the management system to identify one PLMN containing the management system, and QMC ID is a 3-byte Octet String.
   The QMC ID is generated by the management system or the operator.
   It is used to identify the QoE measurement collection job in the traffic nodes and in the measurement collection center.

The UE AS layer can report to a gNB the RAN visible QoE measurements in RRC format, and a UE Application Layer can be configured for performing more application layer measurements at the same time (in NR Rel-17 up to 16) and, e.g., in 3GPP TS 38.331, an application layer measurement is identified by the MeasConfigAppLayerId IE.

In a gNB, RAN visible QoE information can be transferred from gNB-CU to the gNB-DU in a procedure described in 3GPP TS 38.473 v17.0.0. The procedure is UE-associated, i.e., it is specific for a UE.

### QoE Information Transfer

The purpose of the QoE Information Transfer procedure is to transfer RAN visible QoE information from the gNB-CU to the gNB-DU. The procedure uses UE-associated signaling. FIG. 5 shows a QoE transfer procedure. The gNB-CU initiates the procedure by sending the QOE INFORMATION TRANSFER message to the gNB-DU. If the QoE Information List IE is included in QOE INFORMATION TRANSFER message, the gNB-DU may take it into account according to 3GPP TS 38.300.

A message is sent by a gNB-CU to a gNB-DU, to indicate information related to RAN visible QoE. Direction: gNB-CU→gNB-DU. FIG. 6 shows two tables including parameters associated with QoE information transfer.

### QoE Metrics

FIG. 7 shows typical QoE metrics. The IE provides the RAN visible QoE measurement report to gNB-DU.

In contribution R3-223128 to 3GPP TSG-RAN WG3 Meeting #116-e, the association of RAN visible QoE report to a reference was discussed:
In F1AP a list containing currently agreed RVQoE metric is transferred over F1 using UE-associated signalling. But the reports are not associated with e.g., any reference or other id. So, the gNB-DU will not know how many different application sessions that provide reports, and the currently defined signalling will therefore not allow the gNB-DU to distinguish between QoE reports coming from the different application sessions. Also, the gNB-DU will not be able to group reports that it successively receives from a given application session and will therefore not be able to trace e.g., any tendencies in the reported data.
Candidate reference or other ID that could solve this issue would typically be the QoE reference or the short RRC id (measConfigAppLayerId) allocated by the UE. In the F1AP CR submitted to the present meeting in R3-223131, we propose to use the QoE reference, but the ultimate choice may be subject for further evaluation.

In the same contribution, the following proposal is made according to the reported discussion:
Proposal 3: RAN3 to discuss and agree on identifying RVQoE report information over F1 using QoE Reference or short RRC id (measConfigAppLayerId).

### Signaling Radio Bearer (SRB)

Signaling Radio Bearers are configured in the UE for transmission of control plane messages to and from the UE. In current specifications, five different SRBs may be configured. SRB0 is used for initial RRC setup, before any security is activated. SRB1 is used for most RRC messages and SRB2 for NAS messages.

If the UE is configured with dual connectivity (DC), SRB1 is used for communicating with the Master Node (MN). The UE may in DC also be configured with SRB3, which is used for direct communication between the UE and the Secondary Node (SN).

For the transmission of QoE and RVQoE reports, a dedicated SRB4 has been defined. SRB4 is in Rel-17 only being used for transmission of QoE and RVQoE reports in the RRC message MeasurementReportAppLayer, to a Master Node

For management-based (m-based) QoE and RVQoE measurement collection, a likely scenario is that both nodes serving a UE in NR Dual Connectivity (NR-DC) (e.g., the MN and SN) will be in the group of RAN node that receive the same management-based (m-based) QoE measurement configuration, e.g., because both the MN and SN will be in the Area Scope of the said m-based configuration. Based on the information received together with this QoE configuration, the RAN node (MN and/or SN) may configure the UE to also execute RVQOE measurements for the same application session.

For management-based (m-based) QoE and RVQoE measurement collection, a likely scenario is that both nodes serving a UE in NR Dual Connectivity (NR-DC) (e.g., the MN and SN) will be in the group of RAN node that receive the same management-based (m-based) QoE measurement configuration, for example because both the MN and SN will be in the Area Scope of the said m-based configuration. Based on the information received together with this QoE configuration, the RAN node (MN and/or SN) may configure the UE to also execute RVQoE measurements for the same application session.

According to the 3GPP specifications, the UE will deliver the QoE and RVQoE reports to the network by using SRB4. In that respect, a UE may have only one SRB of a certain type established, meaning that it cannot establish an SRB4 to both nodes serving it. Further, a likely scenario is that the application session subject to QoE and RVQoE measurements is carried only via one leg to the dual connected UE, where the RAN has no control or immediate knowledge of which leg carries this application session, since it does not know (or at least does not know in advance) which bearer maps to which application session. Consequently, the corresponding RVQoE reports would be of use only for one of the two RAN nodes serving the UE (the one that carries the data for the application session to the UE), while the RVQoE reports would be of no use for the other RAN node serving the UE, even if this RAN node is the one that configured the UE with the RVQoE measurements.

In other words, it is unclear how to ensure that the “correct” RAN node (out of the two serving a UE in NR-DC) receives the RVQoE reports. Note that the problem would have existed even if a UE in NR-DC would be allowed to establish SRB4 towards both RAN nodes that serve it.

Moreover, a RAN node may configure a UE with RVQoE measurements only if the UE is configured with the corresponding QoE measurements at the same time, which effectively means that a RAN node may configure a UE with RVQoE measurements only if the OAM approves it.

Another aspect to consider is that, even if a UE can have only one SRB4 configured, it may have received multiple RVQoE configurations corresponding to different service types (e.g., it has received a first RVQoE configuration for service type 1 from first node, and (later) a second RVQoE configuration for service type 2 from second node) from different RAN nodes. It also is unclear how to ensure that each node receives the RVQoE reports pertaining to the service type(s) for which the node issued to the UE the corresponding RVQoE configuration (in the example, how to make sure the first node receives RVQoE reports pertaining to service type 1 and second node receives RVQoE reports pertaining to service type 2).

### SUMMARY

Some embodiments advantageously provide methods, systems, and apparatuses for inter-node coordination for reporting in multi-node connectivity environments. In some embodiments, a mechanism (i.e., method) is described. The method enables the RAN nodes (i.e., network nodes) serving a UE in NR-DC or any other multi-radio connectivity setup to at least one of: coordinate; inform each other about which of them has configured RVQOE measurements for a specific service type; identify which of them is carrying the data application session subject to RVQoE measurements pertaining to that specific service type; and forward the corresponding RVQoE reports to the node carrying the data for the application session subject to RVQoE measurements.

In some other embodiments, a UE is configured to send one or more reports to a relevant node (i.e., network node) or for the UE to indicate to which node the RVQOE are targeted. A mechanism for a RAN node to obtain the UE capabilities (with respect to the solutions proposed in this invention) is described.

For a UE in NR-DC, one or more embodiments ensure that the RVQoE report pertaining to a certain service type is forwarded to the right place, i.e., to the RAN node that can make use of the reports—the node that delivers to the UE the data for the application session subject to RVQoE measurements.

In some embodiments, the UE in DC and the RAN nodes is configured to infer which of the serving RAN node carries the data for the application session subject to RVQOE measurements, which makes it possible, e.g., to forward the RVQoE reports to the right node.

According to one aspect, a method in a first network node configured to communicate with a user equipment (UE) and a second network node is described. At least the UE is configurable to communicate using multi-radio connectivity with the first network node and the second network node. The method includes coordinating with the second network node to determine which one of the first network node and the second network node has a report corresponding to a service type associated with the UE, determining which one of the first network node and the second network node carries data for an application session subject to quality of experience measurements associated with the report, and performing one or more actions to ensure that one of the first network node and the second network node which carries the data obtains the report.

In some embodiments, the coordination includes transmitting to the second network node a first indication indicating that the first network node has received the report from the UE or receiving from the second network node a second indication indicating that the second network node has received the report from the UE.

In some other embodiments, the report includes one or more of a data radio bearer (DRB) identifier (ID), a quality of service (QoS) flow ID, and a packet data unit (PDU) session ID. The determining which one of the first network node and the second network node carries the data for the application session is based on one or more of the DRB ID, the QoS flow ID, and the PDU session ID.

In some embodiments, the method further includes receiving the report from the UE.

In some other embodiments, performing the one or more actions includes transmitting the report to the second network node when the second network node carries the data for the application session. The transmitted report is usable by the second network node to one or both of transmit to and receive from the UE signaling associated with the service type.

In some embodiments, performing the one or more actions includes receiving the report from the second network node when the first network node carries the data for the application session. The received report is usable by the first network node to one or both of transmit to and receive from the UE signaling associated with the service type.

In some other embodiments, the method further includes causing the UE to be configured to one or both of transmit the report to at least one of the first and second network nodes and indicate to which one of the first network node and second network node the quality of experience is targeted.

In some embodiments, one or both of the first and second network nodes are radio access network, RAN, nodes and the quality of experience measurements are one or both of quality of experience measurements (QoE) measurements, and RAN visible quality of experience (RVQoE) measurements.

In some other embodiments, the report includes one or more of a quality of experience (QoE) report and a radio access network (RAN) visible quality of experience (RVQoE) report.

In some embodiments, the method further includes receiving from the UE a capability indication indicating one of the first network node and the second network node which carries the application session.

According to another aspect, a first network node configured to communicate with a user equipment (UE) and a second network node is described. At least the UE is configurable to communicate using multi-radio connectivity with the first network node and the second network node. The first network node is configured to coordinate with the second network node to determine which one of the first network node and the second network node has a report corresponding to a service type associated with the UE, determine which one of the first network node and the second network node carries data for an application session subject to quality of experience measurements associated with the report, and perform one or more actions to ensure that one of the first network node and the second network node which carries the data obtains the report.

In some embodiments, the coordination includes transmitting to the second network node a first indication indicating that the first network node has received the report from the UE or receiving from the second network node a second indication indicating that the second network node has received the report from the UE.

In some other embodiments, the report includes one or more of a data radio bearer (DRB) identifier (ID), a quality of service (QoS) flow ID, and a packet data unit (PDU) session ID. The determining which one of the first network node and the second network node carries the data for the application session is based on one or more of the DRB ID, the QoS flow ID, and the PDU session ID.

In some embodiments, the first network node is further configured to receive the report from the UE.

In some other embodiments, performing the one or more actions includes transmitting the report to the second network node when the second network node carries the data for the application session. The transmitted report is usable by the second network node to one or both of transmit to and receive from the UE signaling associated with the service type.

In some embodiments, performing the one or more actions includes receiving the report from the second network node when the first network node carries the data for the application session. The received report is usable by the first network node to one or both of transmit to and receive from the UE signaling associated with the service type.

In some other embodiments, the first network node is further configured to cause the UE to be configured to one or both of transmit the report to at least one of the first and second network nodes and indicate to which one of the first network node and second network node the quality of experience is targeted.

In some embodiments, one or both of the first and second network nodes are radio access network, RAN, nodes and the quality of experience measurements are one or both of quality of experience measurements (QoE) measurements, and RAN visible quality of experience (RVQoE) measurements.

In some other embodiments, the report includes one or more of a quality of experience (QoE) report and a radio access network (RAN) visible quality of experience (RVQoE) report.

In some embodiments, the first network node is further configured to receive from the UE a capability indication indicating one of the first network node and the second network node which carries the application session.

According to an aspect, a method in a user equipment (UE) configured to communicate using multi-radio connectivity with a first network node and a second network node is described. The method includes transmitting, to one of the first network node and the second network node, a report corresponding to a service type associated with the UE. The report includes one or more of a data radio bearer (DRB) identifier (ID) a quality of service (QoS) flow ID, and a packet data unit (PDU) session ID. Which one of the first network node and the second network node carries data for an application session being determined based on one or more of the DRB ID, the QoS flow ID, and the PDU session ID.

In some embodiments, the method further includes determining a capability indication usable by one or both of the first network node and the second network node to determine which one of the first network node and the second network node carries the data for the application session subject to quality of experience measurements associated with the report and perform one or more actions to ensure that one of the first network node and the second network node which carries the data obtains the report. The method further includes transmitting the capability indication to one or both of the first network node and the second network node.

In some other embodiments, when the report is transmitted to the first network node, the one or more actions includes transmitting, by the first network node, the report to the second network node when the second network node carries the data for the application session. The transmitted report is usable by the second network node to one or both of transmit to and receive from the UE signaling associated with the service type.

In some embodiments, the one or more actions includes receiving, by the first network node, the report from the second network node when the first network node carries the data for the application session. The received report is usable by the first network node to one or both of transmit to and receive from the UE signaling associated with the service type.

In some other embodiments, the quality of experience measurements are one or both of quality of experience measurements (QoE) measurements, and radio access network (RAN) visible quality of experience (RVQoE) measurements.

In some embodiments, the method further includes indicating to which one of the first network node and the second network node the quality of experience is targeted.

In some other embodiments, the first and second network nodes 16a, 16b are radio access network (RAN) nodes.

In some embodiments, the report includes a quality of experience (QoE) report. In some other embodiments, the report includes a radio access network (RAN) visible quality of experience (RVQoE) report.

In some embodiments, the method further includes determining the report based on one or both of a first configuration and a second configuration received from one or both of the first network node and the second network node.

According to another aspect, a user equipment (UE) configured to communicate using multi-radio connectivity with a first network node and a second network node. The UE is configured to cause transmission, to one of the first network node and the second network node, of a report corresponding to a service type associated with the UE. The report includes one or more of a data radio bearer (DRB) identifier (ID) a quality of service (QoS) flow ID, and a packet data unit (PDU) session ID. Which one of the first network node and the second network node carries data for an application session being determined based on one or more of the DRB ID, the QoS flow ID, and the PDU session ID.

In some embodiments, the UE is further configured to determine a capability indication usable by one or both of the first network node and the second network node to determine which one of the first network node and the second network node carries the data for the application session subject to quality of experience measurements associated with the report and perform one or more actions to ensure that one of the first network node and the second network node which carries the data obtains the report. The UE is further configured to cause transmission of the capability indication to one or both of the first network node and the second network node.

In some other embodiments, when the report is transmitted to the first network node, the one or more actions includes transmitting, by the first network node, the report to the second network node when the second network node carries the data for the application session. The transmitted report is usable by the second network node to one or both of transmit to and receive from the UE signaling associated with the service type.

In some embodiments, the one or more actions includes receiving, by the first network node, the report from the second network node when the first network node carries the data for the application session. The received report is usable by the first network node to one or both of transmit to and receive from the UE signaling associated with the service type.

In some other embodiments, the quality of experience measurements are one or both of quality of experience measurements (QoE) measurements, and radio access network (RAN) visible quality of experience (RVQoE) measurements.

In some embodiments, the UE is further configured to indicate to which one of the first network node and the second network node the quality of experience is targeted.

In some other embodiments, the first and second network nodes 16a, 16b are radio access network (RAN) nodes.

In some embodiments, the report includes a quality of experience (QoE) report. In some other embodiments, the report includes a radio access network (RAN) visible quality of experience (RVQoE) report.

In some embodiments, the UE is further configured to determine the report based on one or both of a first configuration and a second configuration received from one or both of the first network node and the second network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an overall architecture of NG-RAN;

FIG. 2 shows an overall architecture for separation of gNB-CU-CP and gNB-CU-UP;

FIG. 3 shows an EN-DC overall architecture;

FIG. 4 shows a second node addition procedure;

FIG. 5 shows a QoE transfer procedure;

FIG. 6 shows two tables including parameters associated with QoE information transfer;

FIG. 7 shows typical QoE metrics;

FIG. 8 is a schematic diagram of an example network architecture illustrating a communication system connected via an intermediate network to a host computer according to the principles in the present disclosure;

FIG. 9 is a block diagram of a host computer communicating via a network node with a user equipment over an at least partially wireless connection according to some embodiments of the present disclosure;

FIG. 10 is a flowchart illustrating example methods implemented in a communication system including a host computer, a network node and a user equipment for executing a client application at a user equipment according to some embodiments of the present disclosure;

FIG. 11 is a flowchart illustrating example methods implemented in a communication system including a host computer, a network node and a UE for receiving user data at a user equipment according to some embodiments of the present disclosure;

FIG. 12 is a flowchart illustrating example methods implemented in a communication system including a host computer, a network node and a user equipment for receiving user data from the user equipment at a host computer according to some embodiments of the present disclosure;

FIG. 13 is a flowchart illustrating example methods implemented in a communication system including a host computer, a network node and a user equipment for receiving user data at a host computer according to some embodiments of the present disclosure;

FIG. 14 is a flowchart of an example process in a network node according to some embodiments of the present disclosure;

FIG. 15 is a flowchart of an example process in a user equipment according to some embodiments of the present disclosure;

FIG. 16 is a flowchart of another example process in a network node according to some embodiments of the present disclosure; and

FIG. 17 is a flowchart of another example process in a user equipment according to some embodiments of the present disclosure.

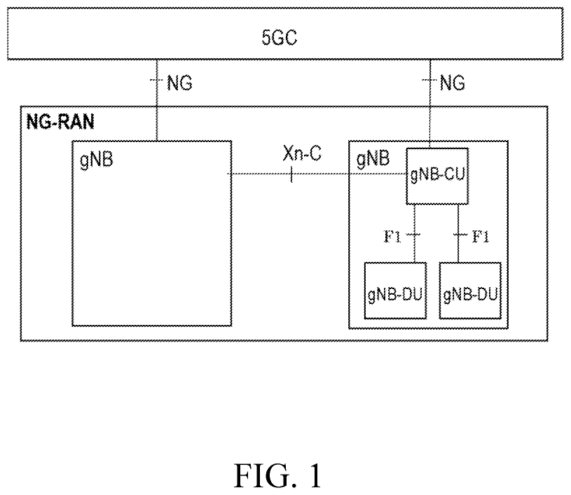

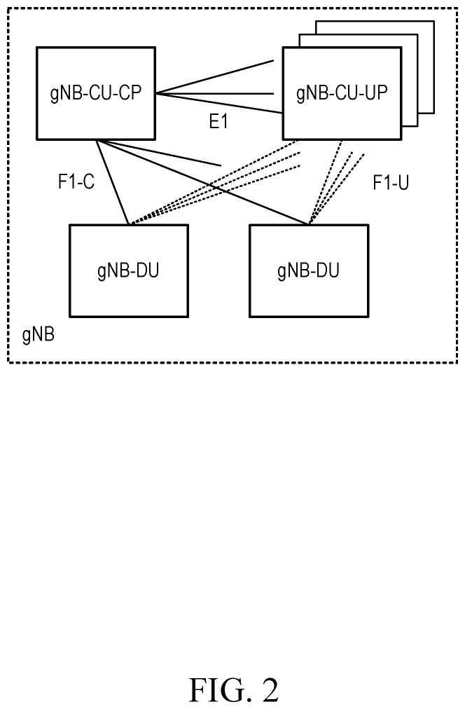

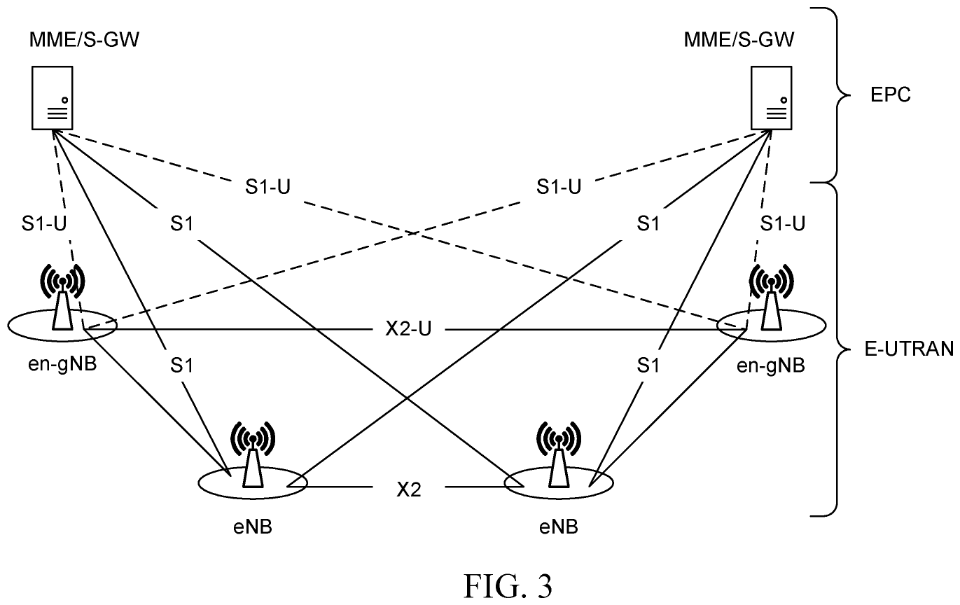

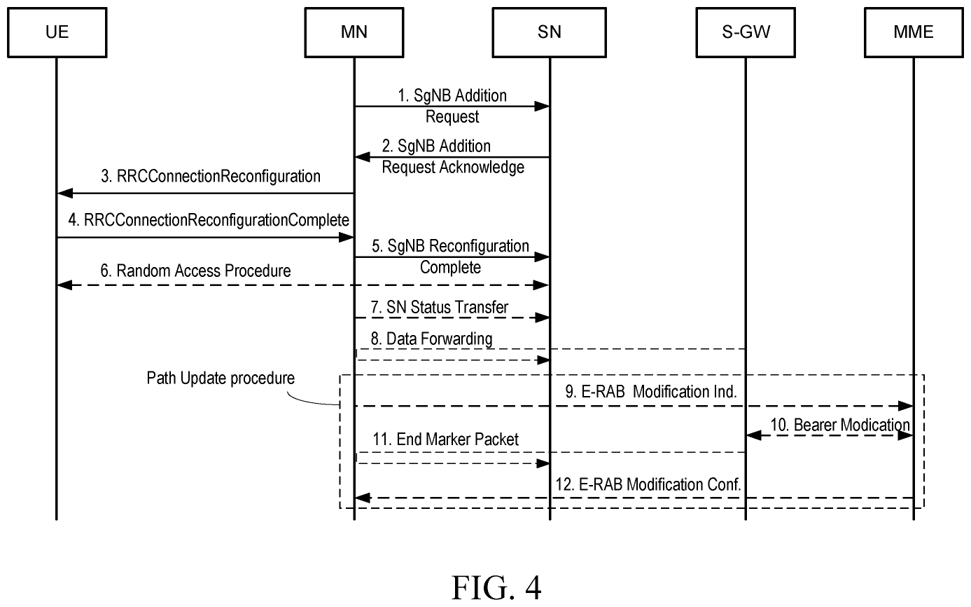

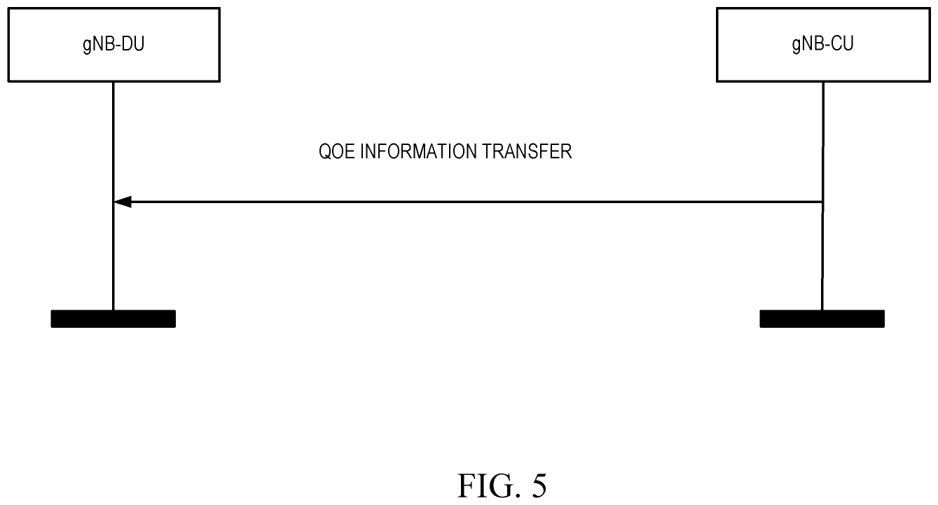

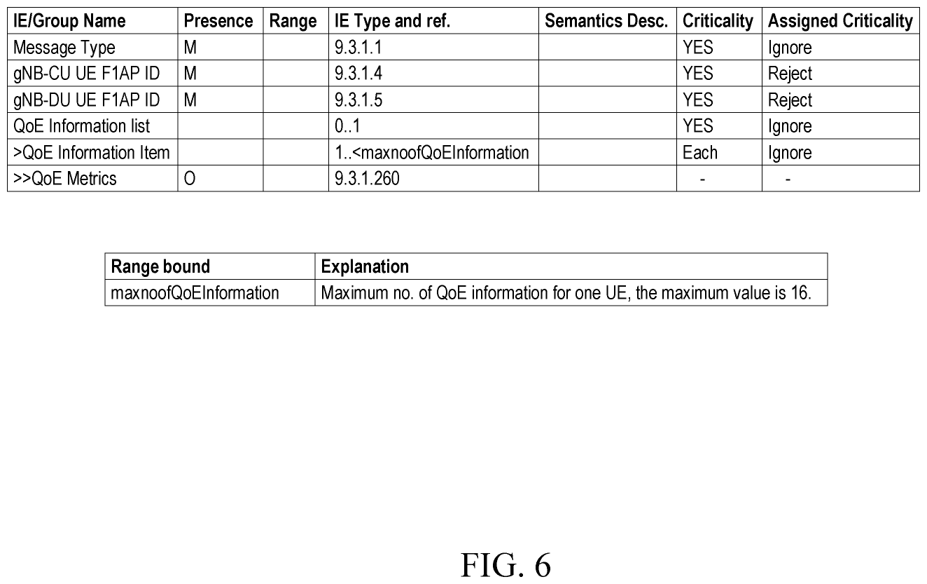

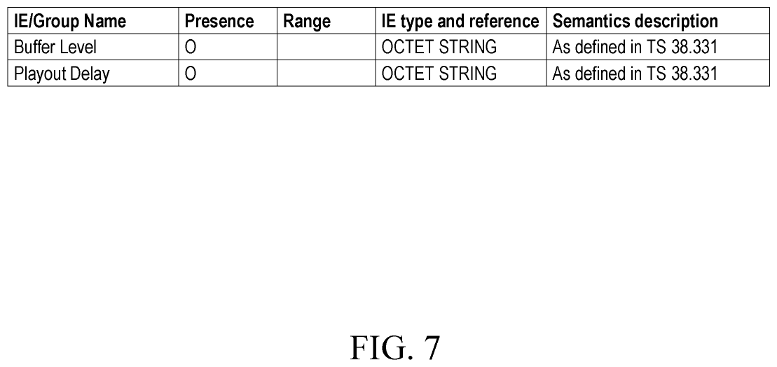

### DETAILED DESCRIPTION

Before describing in detail example embodiments, it is noted that the embodiments reside primarily in combinations of apparatus components and processing steps related to inter-node coordination, e.g., for reporting in multi-node connectivity environments. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node (and/or node) comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a UE (such as a wireless device (WD) or a radio network node).

In some embodiments, the non-limiting terms user equipment (UE) or wireless device (WD) are used interchangeably. The UE herein can be any type of user equipment (e.g., wireless device) capable of communicating with a network node or another UE over radio signals, such as user equipment (UE). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc. Although a UE is described, any WD can be implemented. Further, a UE may be considered the same as a WD and not limited to a particular type of wireless device.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In one or more embodiments, one or more of the following may apply:
The solution herein is described on an example of two RAN nodes serving the UE in NR-DC, but it can be generalized to an arbitrary number of nodes simultaneously serving the UE.
The solution herein is described on an example of NR-DC, but it can be generalized to Multi Radio Dual Connectivity (MR-DC) or to connectivity options with more than two RAN nodes as well.
The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected, etc.
All references to the application layer are with respect to the application layer of the UE (since RAN nodes do not have an application layer).
The term “service” is often used as a short notation for “service type”. Therefore, “service” and “service types” may be interchangeably, e.g., unless explicitly stated.
The solution proposed in this invention may apply to both signaling- and management-based QoE measurements (but may also optionally be restricted to apply to only one of them).
The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.
The terms “access stratum” and “radio layer” are used interchangeably when referring to a UE.
The term “session” may refer to either a QoE measurement session or an application session or an application session for which QoE measurement is applied.
The term “session” may refer to either a QoE measurement session or an application session or an application session for which QoE measurement is applied.
The solution proposed in this invention applies to UMTS, LTE and NR as well as future RATs such as 6G.
The solution is described on the example of management based QoE measurements (i.e., their corresponding RVQoE measurements), but it is equally applicable to both management-based and signaling-based QoE measurements, as well as their corresponding RVQoE measurements.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a user equipment or a network node may be distributed over a plurality of user equipment (UEs) and/or network nodes. In other words, it is contemplated that the functions of the network node and user equipment described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

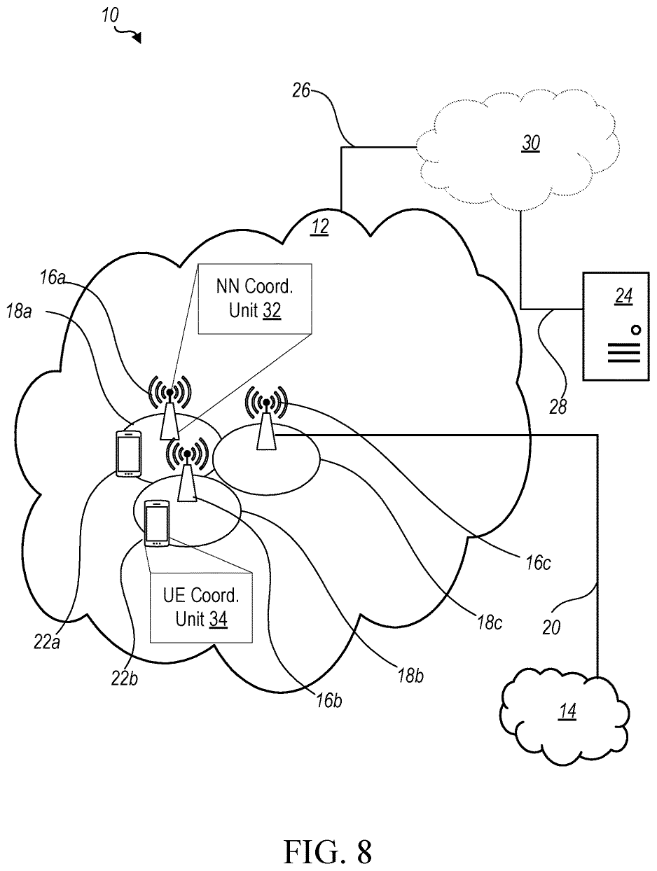

Referring again to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 can be in simultaneous communication and/or configured to separately communicate with more than one network node 16 and more than one type of network node 16. For example, a UE 22 can have dual connectivity with a network node 16 that supports LTE and the same or a different network node 16 that supports NR. As an example, UE 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 8 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a NN coordination unit 32 which is configured to perform any step and/or task and/or process and/or method and/or feature described in the present disclosure, e.g., transmit information to the second network node about which one of the first and second network nodes has configured quality of experience measurements for a predetermined service type associated with the UE; and/or determine which one of the first and second network nodes carries data for an application session subject to the quality of experience measurements for the predetermined service type; and/or forward a quality of experience report corresponding to the application session to the second network node when the second network node carries the data for the application session subject to quality of experience measurements. A user equipment 22 is configured to include a UE coordination unit 34 which is configured to perform any step and/or task and/or process and/or method and/or feature described in the present disclosure, e.g., determine that data for an application session subject to quality of experience measurements for a predetermined service type associated with the UE 22 is carried by the second network node; and/or transmit an indication at least to the first network node 16a, the indication indicating that the data for the application session subject to the quality of experience measurements for the predetermined service type is carried by the second network node, the indication being usable by the first network node to forward, to the second network node, a quality of experience report corresponding to the application session.

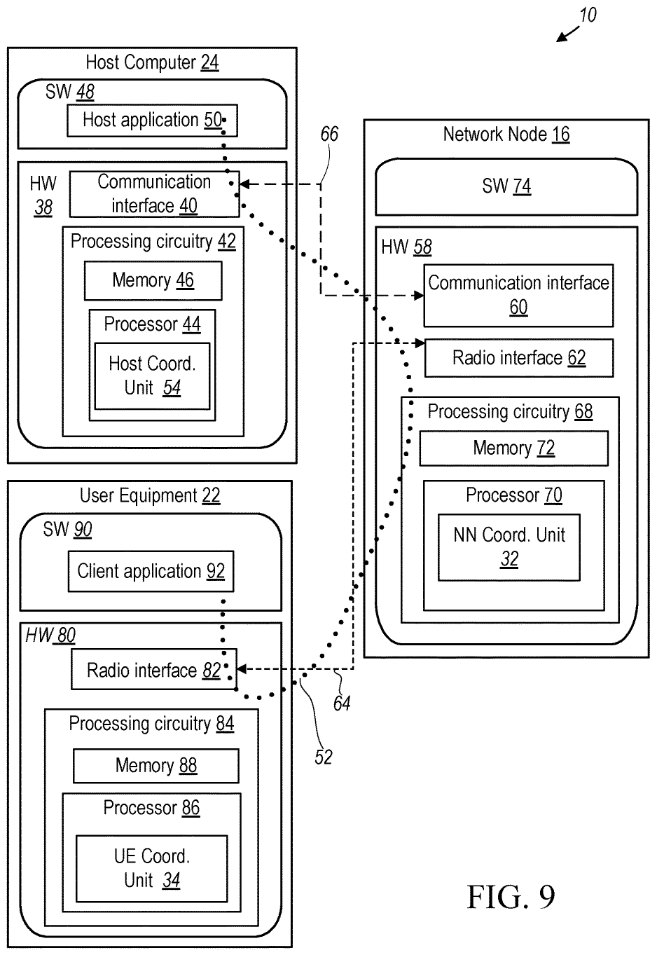

Example implementations, in accordance with an embodiment, of the UE 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the user equipment 22. The processing circuitry 42 of the host computer 24 may include a host coordination unit 54 configured to enable the service provider to perform any step and/or task and/or process and/or method and/or feature described in the present disclosure, e.g., observe/monitor/control/transmit to/receive from the network node 16 and or the user equipment 22.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include UE coordination unit 34 perform any step and/or task and/or process and/or method and/or feature described in the present disclosure, e.g., transmit information to the second network node about which one of the first and second network nodes has configured quality of experience measurements for a predetermined service type associated with the UE; and/or determine which one of the first and second network nodes carries data for an application session subject to the quality of experience measurements for the predetermined service type; and/or forward a quality of experience report corresponding to the application session to the second network node when the second network node carries the data for the application session subject to quality of experience measurements.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the UE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the user equipment 22 may include a UE coordination unit 34 configured to perform any step and/or task and/or process and/or method and/or feature described in the present disclosure, e.g., determine that data for an application session subject to quality of experience measurements for a predetermined service type associated with the UE is carried by the second network node; and/or transmit an indication at least to the first network node, the indication indicating that the data for the application session subject to the quality of experience measurements for the predetermined service type is carried by the second network node, the indication being usable by the first network node to forward, to the second network node, a quality of experience report corresponding to the application session.

In some embodiments, the inner workings of the network node 16, UE 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the user equipment 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22 and the network node 16 is in accordance with the teachings of the embodiments described throughout this disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as NN coordination unit 32, and UE coordination unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

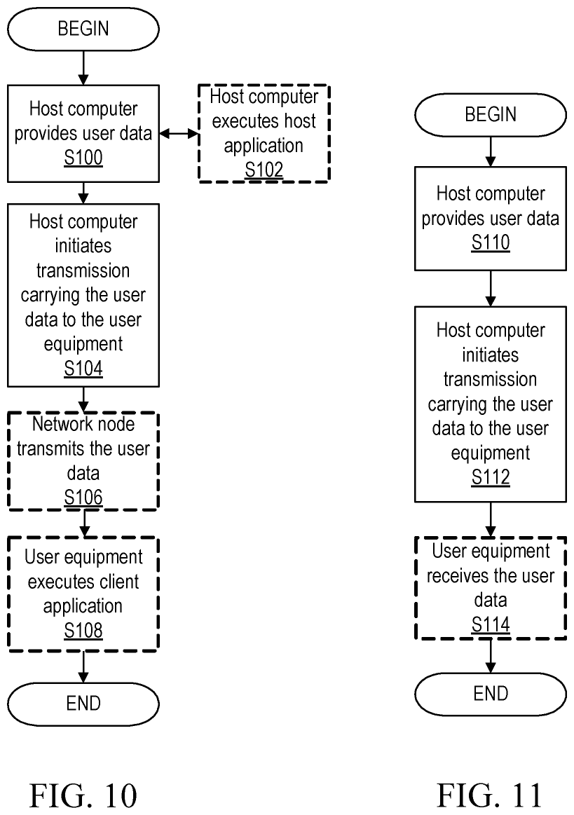

FIG. 10 is a flowchart illustrating an example method implemented in a communication system, such as, for example, the communication system of FIGS. 8 and 9, in accordance with one embodiment. The communication system may include a host computer 24, a network node 16 and a UE 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 11 is a flowchart illustrating an example method implemented in a communication system, such as, for example, the communication system of FIG. 8, in accordance with one embodiment. The communication system may include a host computer 24, a network node 16 and a UE 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

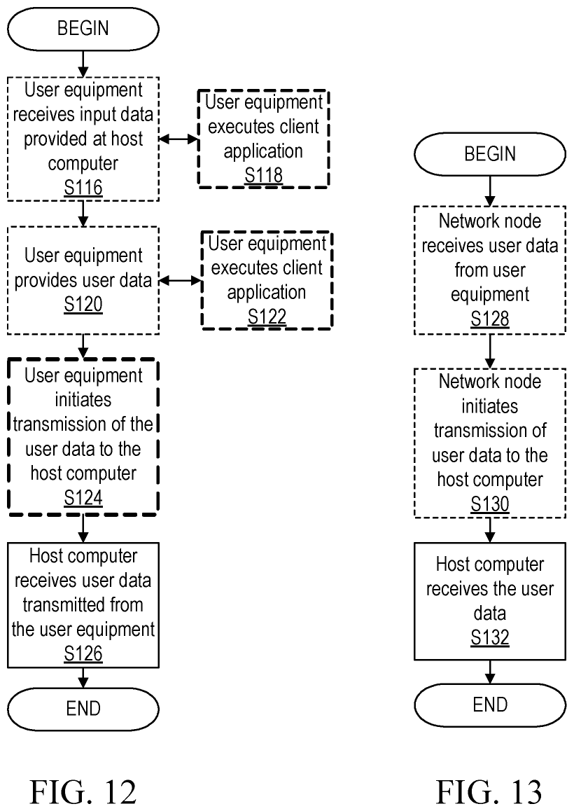

FIG. 12 is a flowchart illustrating an example method implemented in a communication system, such as, for example, the communication system of FIG. 8, in accordance with one embodiment. The communication system may include a host computer 24, a network node 16 and a UE 22, which may be those described with reference to FIGS. 8 and 9. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 13 is a flowchart illustrating an example method implemented in a communication system, such as, for example, the communication system of FIG. 8, in accordance with one embodiment. The communication system may include a host computer 24, a network node 16 and a UE 22, which may be those described with reference to FIGS. 8 and 9. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

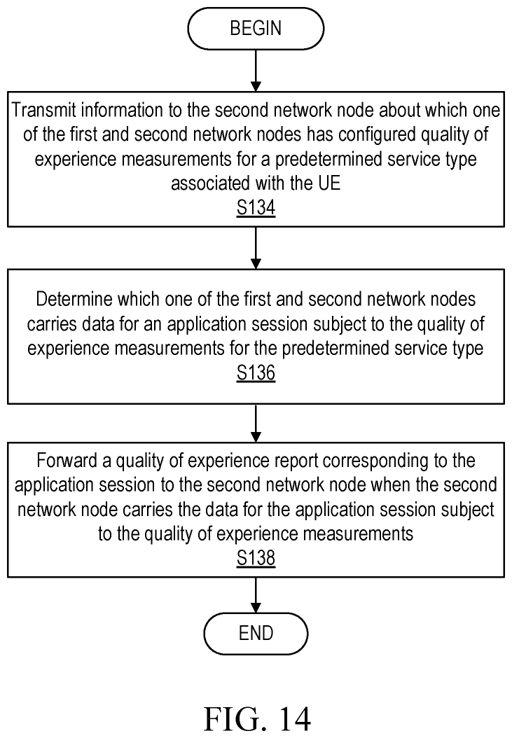

FIG. 14 is a flowchart of an example process in a network node 16 (e.g., a first network node 16a). One or more blocks described herein may be performed by one or more elements of network node 16 such as by one or more of processing circuitry 68 (including the NN coordination unit 32), processor 70, radio interface 62 and/or communication interface 60. Network node 16 such as via processing circuitry 68 and/or processor 70 and/or radio interface 62 and/or communication interface 60 is configured to transmit (Block S134) information to the second network node 16b about which one of the first and second network nodes 16a, 16b has configured quality of experience measurements for a predetermined service type associated with the UE 22; determine (Block S136) which one of the first and second network nodes 16a, 16b carries data for an application session subject to the quality of experience measurements for the predetermined service type; and forward (Block S138) a quality of experience report corresponding to the application session to the second network node 16b when the second network node 16b carries the data for the application session subject to the quality of experience measurements.

In some embodiments, the method further includes configuring the UE 22 to at least one of: transmit the quality of experience report to at least one of the first and second network nodes 16a, 16b; and indicate to which one of the first and second network nodes 16a, 16b the quality of experience is targeted.

In some other embodiments, at least one of: the first and second network nodes 16a, 16b are radio access network, RAN, nodes; the UE 22 is configurable to transmit a capability indication to at least one of the first and second network nodes 16a, 16b; the quality of experience measurements are RAN visible quality of experience, RVQoE, measurements; and the quality of experience report is an RVQoE report.

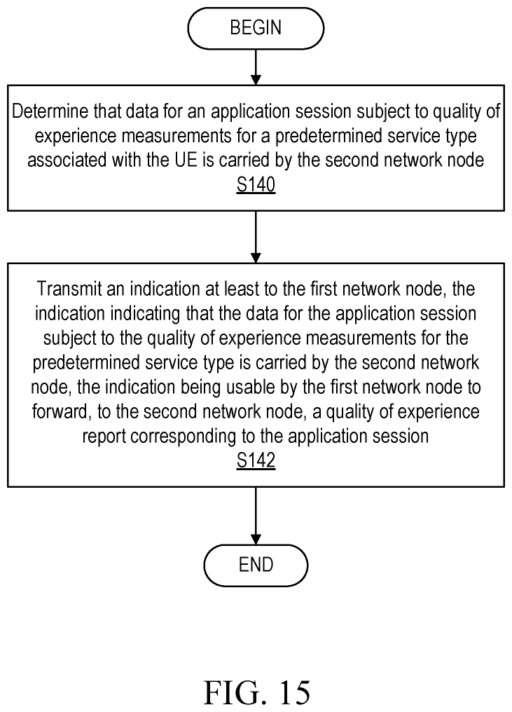

FIG. 15 is a flowchart of an example process in a user equipment 22 according to some embodiments of the present disclosure. One or more blocks described herein may be performed by one or more elements of user equipment 22 such as by one or more of processing circuitry 84 (including the UE coordination unit 34), processor 86, radio interface 82 and/or communication interface 60. User equipment 22 such as via processing circuitry 84 and/or processor 86 and/or radio interface 82 is configured to determine (Block S140) that data for an application session subject to quality of experience measurements for a predetermined service type associated with the UE 22 is carried by the second network node 16b; and transmit (Block S142) an indication at least to the first network node 16a. The indication indicates that the data for the application session subject to the quality of experience measurements for the predetermined service type is carried by the second network node 16b. The indication is usable by the first network node 16a to forward, to the second network node 16b, a quality of experience report corresponding to the application session.

In some embodiments, the UE 22 is configured by at least one of the first and second network nodes 16a, 16b to transmit the quality of experience report to at least one of the first and second network nodes 16a, 16b.

In some other embodiments, at least one of: the first and second network nodes 16a, 16b are radio access network, RAN, nodes; the UE 22 is configurable to transmit a capability indication to at least one of the first and second network nodes 16a, 16b; the quality of experience measurements are RAN visible quality of experience, RVQOE, measurements; and the quality of experience report is an RVQoE report.

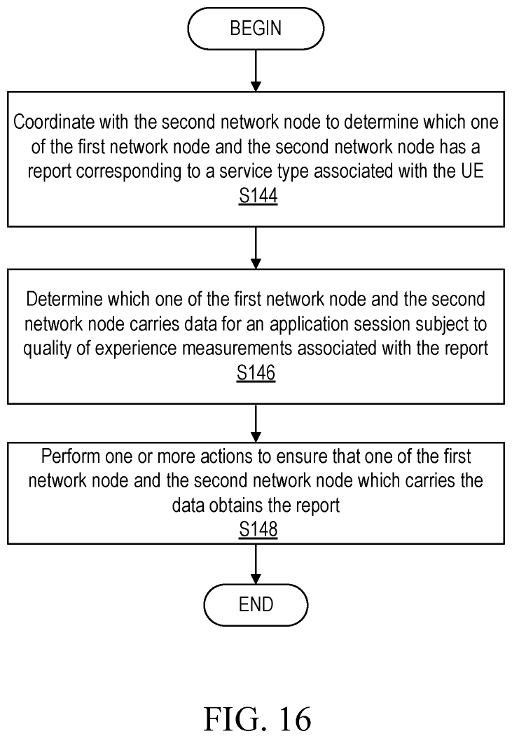

FIG. 16 is a flowchart of an example process in a network node 16 (e.g., a first network node 16a). One or more blocks described herein may be performed by one or more elements of network node 16 such as by one or more of processing circuitry 68 (including the NN coordination unit 32), processor 70, radio interface 62 and/or communication interface 60. Network node 16 (e.g., a first network node 16a) such as via processing circuitry 68 and/or processor 70 and/or radio interface 62 and/or communication interface 60 is configured to coordinate (Block S144) with the second network node 16b to determine which one of the first network node 16a and the second network node 16b has a report corresponding to a service type associated with the UE 22 and determine (Block S142) which one of the first network node 16a and the second network node 16b carries data for an application session subject to quality of experience measurements associated with the report. Network node 16 (e.g., a first network node 16a) is further configured to perform one or more actions to ensure that one of the first network node 16a and the second network node 16b which carries the data obtains the report.

In some embodiments, the coordination includes transmitting to the second network node 16b a first indication indicating that the first network node 16a has received the report from the UE or receiving from the second network node 16b a second indication indicating that the second network node 16b has received the report from the UE.

In some other embodiments, the report includes one or more of a data radio bearer (DRB) identifier (ID), a quality of service (QoS) flow ID, and a packet data unit (PDU) session ID. The determining which one of the first network node 16a and the second network node 16b carries the data for the application session is based on one or more of the DRB ID, the QoS flow ID, and the PDU session ID.

In some embodiments, the method further includes receiving the report from the UE.

In some other embodiments, performing the one or more actions includes transmitting the report to the second network node 16b when the second network node 16b carries the data for the application session. The transmitted report is usable by the second network node 16b to one or both of transmit to and receive from the UE signaling associated with the service type.

In some embodiments, performing the one or more actions includes receiving the report from the second network node 16b when the first network node 16a carries the data for the application session. The received report is usable by the first network node 16a to one or both of transmit to and receive from the UE signaling associated with the service type.

In some other embodiments, the method further includes causing the UE to be configured to one or both of transmit the report to at least one of the first and second network nodes 16a, 16b and indicate to which one of the first network node 16a and second network node 16b the quality of experience is targeted.

In some embodiments, one or both of the first and second network nodes 16a, 16b are radio access network (RAN) nodes and the quality of experience measurements are one or both of quality of experience (QoE) measurements and RAN visible quality of experience (RVQoE) measurements.

In some other embodiments, the report includes one or more of a quality of experience (QoE) report and a radio access network (RAN) visible quality of experience (RVQoE) report.

In some embodiments, the method further includes receiving from the UE a capability indication indicating one of the first network node 16a and the second network node 16b which carries the application session.

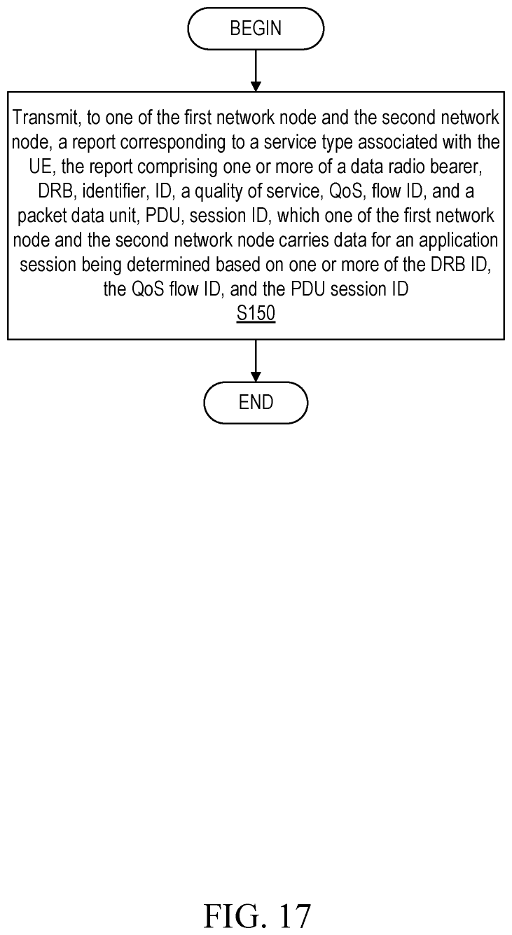

FIG. 17 is a flowchart of an example process in a user equipment 22 according to some embodiments of the present disclosure. One or more blocks described herein may be performed by one or more elements of user equipment 22 such as by one or more of processing circuitry 84 (including the UE coordination unit 34), processor 86, radio interface 82 and/or communication interface 60. User equipment 22 such as via processing circuitry 84 and/or processor 86 and/or radio interface 82 is configured to transmit (Block S150), to one of the first network node 16a and the second network node 16b, a report corresponding to a service type associated with the UE 22, the report comprising one or more of a data radio bearer (DRB) identifier (ID), a quality of service (QoS) flow ID, and a packet data unit (PDU) session ID, which one of the first network node 16a and the second network node 16b carries data for an application session being determined based on one or more of the DRB ID, the QoS flow ID, and the PDU session ID.

In some embodiments, the method further includes determining a capability indication usable by one or both of the first network node 16a and the second network node 16b to determine which one of the first network node 16a and the second network node 16b carries the data for the application session subject to quality of experience measurements associated with the report and perform one or more actions to ensure that one of the first network node 16a and the second network node 16b which carries the data obtains the report. The method further includes transmitting the capability indication to one or both of the first network node 16a and the second network node 16b.

In some other embodiments, when the report is transmitted to the first network node 16a, the one or more actions includes transmitting, by the first network node 16a, the report to the second network node 16b when the second network node 16b carries the data for the application session. The transmitted report is usable by the second network node 16b to one or both of transmit to and receive from the UE 22 signaling associated with the service type.

In some embodiments, the one or more actions includes receiving, by the first network node 16a, the report from the second network node 16b when the first network node 16a carries the data for the application session. The received report is usable by the first network node 16a to one or both of transmit to and receive from the UE 22 signaling associated with the service type.

In some other embodiments, the quality of experience measurements are one or both of quality of experience measurements (QoE) measurements, and radio access network (RAN) visible quality of experience (RVQoE) measurements.

In some embodiments, the method further includes indicating to which one of the first network node 16a and the second network node 16b the quality of experience is targeted.

In some other embodiments, the first and second network nodes 16a, 16b are radio access network (RAN) nodes.

In some embodiments, the report includes a quality of experience (QoE) report.

In some other embodiments, the report includes a radio access network (RAN) visible quality of experience (RVQoE) report.

In some embodiments, the method further includes determining the report based on one or both of a first configuration and a second configuration received from one or both of the first network node 16a and the second network node 16b.

Having described the general process flow of arrangements of the disclosure and having provided examples of hardware and software arrangements for implementing the processes and functions of the disclosure, the sections below provide details and examples of arrangements for inter-node coordination, e.g., for reporting in multi-node connectivity environments.

Some embodiments provide a UE 22 (e.g., a WD), a first network node 16a (e.g., first node), and a second network node 16b (e.g., a second node).

### First Example Solution: UE-Based Solution

The first solution includes at least one of the following steps:
1. A UE 22 establishes NR-DC to the first and second network nodes 16a, 16b, which play the role of MN and SN, respectively, or SN and MN, respectively.
2. A network entity, e.g., the OAM, assembles a management-based QoE measurement configuration (herein referred to as the first configuration) and delivers it to a number of RAN nodes in an area, among which are the first network node 16a and the second network node 16b. The first network node 16a configures the UE 22 with QoE measurements for a service, say first service, according to the first configuration, it configures the RVQoE measurements at the UE 22 according to the second configuration, and sets up SRB4 towards the UE 22. Note that the UE 22 may establish only one SRB of each type towards the network, which means that, in the scenario in question, unless reconfigured, the SRB4 is always established either towards the first or second network node 16a, 16b, but not both. The UE 22 activates an application session for a service, say first service, which triggers the QoE and RVQOE measurements at the UE 22 and the reporting thereof.
   a. In case of signaling-based (s-based) QoE, the QoE configuration is delivered from the OAM via the core network to the MN.
   b. In case of management-based (m-based) QoE, it may happen that both first and second network nodes 16a, 16b have received the first configuration (directly from the OAM), e.g., because they are both within the area scope or the configured PLMN(s) of the first configuration.
3. The first and the second nodes 16a, 16b inform each other whether they have both received the first configuration and whether they plan to configure a UE 22 with it. The nodes may also indicate to each other whether they are interested in receiving RVQoE reports pertaining to each measurement configuration. Each node may also inform the other node whether it has established an SRB4 towards the UE 22.
   In one solution, one node (typically the Master Node) decides to configure SRB4 as a split bearer. That means that the UE 22 splits the transmission between the first network node 16a and the second network node 16b. In existing solutions, the spit is based on the amount of data to be transmitted. Here, some new criteria for how the UE 22 splits the transmissions may be defined. As an example, the split may e.g., be based on if the data is for a service of the first or the second network node 16b. If the data is for a service of the first network node 16a, the UE 22 sends the data on the leg to the first network node 16a, and if the data is for a service of the second network node 16b, the UE 22 sends the data on the leg to the second network node 16b. A case of split transmission can be where, according to a configuration provided to at least one of the first or second node 16a, 16b, data pertaining to VoNR service is sent to the first network node 16a, data pertaining to streaming is sent to the second network node 16b. An additional criterion is that one of the legs is prioritized, or always used instead of the other, until an overload (or a near overload) situation is detected by the node corresponding to the prioritized leg. For example, the SRB4 is configured as split bearer and the prioritized leg corresponds to the node that configured the SRB4 (e.g., the MN). According to the configuration provided, the UE 22 sends data using the MN leg. When MN detects an overload (e.g., MN detects too many data arriving over SRB4 in a given time period), MN reconfigures the SRB4 so that UE 22 will now send data pertaining to QoE/RVQoE reports via another leg. In another solution, one node (typically the Master Node) decides to configure SRB4 as a duplicated bearer. That means that the data is sent to both the first network node 16a and the second network node 16b. Each node may then determine whether the data is for a service of that particular node or for a service of the other node and take the relevant data for its own node.

In an alternative solution, the message carrying RVQoE reports, e.g., MeasurementReportAppLayer, is allowed to be transmitted over different SRBs in the first network node 16a and in the second network node 16b, i.e., different SRBs are defined. This may comprise using SRB4 in the first network node 16a and using SRB1, SRB3 or a new SRB5 in the second network node 16b. One of the SRBs may be defined as a master node bearer and the other SRB may be defined as a secondary node bearer, or both may be defined as master node bearer or both defined as secondary node bearer.

In yet another example solution, the same SRB is used for RVQoE reports for both first and secondary node, but possibly together with an indication from the UE 22 to which node the reports is aimed for, see Step 4.
a. The first and the second network nodes 16a, 16b can inform each other whether they have received the first configuration and whether they plan to configure a UE 22 with it, during the execution of one of the procedures related to multi-connectivity operation where the UE 22 is reconfigured from single connectivity to multi-connectivity (e.g. Secondary Node Addition), or the UE 22 is reconfigured from a first configuration in multi-connectivity to a second configuration in multi-connectivity (e.g. Secondary Node Modification-MN initiated or SN initiated, Secondary Node Change-MN initiated or SN initiated, Inter-MN handover with/without SN change).
b. One of the nodes involved in NR-DC (or MR-DC) indicates/requests the other node to forward RVQoE reports pertaining to the service for which they have provided the UE 22 with the corresponding RVQoE configuration, and the indication/request is carried over a new or an existing procedure.
   i. In one case, the first network node 16a and the second network node 16b are used already in MR-DC and only one of the nodes is comprised in the area scope. The node receiving the m-based configuration (either the MN node or the SN node) can configure the UE 22 for RVQOE and indicates/request to the other node (SN or MN respectively) to forward to it the RVQoE reports.
   ii. In another case, one of the nodes (typically the MN node) has configured the UE 22 to collect RVQoE for a first service according to an s-based QoE configuration. In this case, the MN is not included in the area scope pertaining to an m-based QoE configuration, while the other node (the SN) is included in the area scope pertaining to the m-based QoE configuration. The other node (SN) configures the UE 22 to collect RVQoE for a second service. The MN indicates/requests to the SN to forward to it the RVQoE reports pertaining to the first service; the SN indicates/request to the MN to forward to it the RVQoE reports pertaining to the second service.
   iii. In another case, at least one of the first network node 16a and/or second network node 16b receives an m-based QoE configuration to be sent to the UE 22 and/or determines to prepare a RVQoE configuration for the UE 22. For example, if it is the first network node 16a, the first network node 16a can inform the second network node 16b that it has configured the UE 22 for RVQOE and is interested in receiving RVQoE reports. With that, the second network node 16b becomes aware of the fact that future RVQoE reports received for the UE 22 at the second network node 16b needs to be sent to the first network node 16a. There is a possible race condition where both first network node 16a and second network node 16b can try to configure the UE 22 with the same RVQoE configuration. In this case, one sub-case is that the newest configuration overrides the older configuration (no RVQoE configuration modification is allowed). In another sub-case, each one of the nodes will receive an indication that the other node is interested in receiving RVQoE reports from the other node. In another sub-case, the node which sent to the UE 22 the RVQOE configuration as the last one of the two, is the one to receive the RVQoE reports. In yet another sub-case, it is the node that sent the RVQoE configuration before the other, is the one to receive the RVQoE reports.
c. One or the nodes when removed from an NR-DC (or MR-DC) configuration indicates/request the other node to receive RVQoE reports pertaining to the service for which it has provided the UE 22 with the corresponding RVQoE configuration, and the indication/request is carried over a new or an existing procedure.

It may be assumed that the first network node 16a has configured the UE 22 with QoE and RVQoE measurements and established the SRB4 towards the UE 22. This is a non-limiting example, e.g., because it may be the case that the second network node 16b has configured the first and second configuration to the UE 22. At this point, neither of the two nodes are aware which of them carries the data for the application session for the first service.
4. The UE 22 realizes that the data for the first service is carried via the second network node 16b. This can be done by the UE Access Stratum (AS) layer, based on the DRB ID, QoS flow ID or PDU session ID of the application session and the knowledge of the corresponding connectivity leg. Note that, as a part of DC setup procedure, the MN indicates to the SN the available DRB IDs to be used by the SN for SCG terminated DRBs, ensuring the uniqueness of DRB IDs set up towards a UE 22 in DC. Instead of this, or in combination with this, the UE 22 may also use one of the methods described below (in section “How a UE identifies the leg carrying application data flows”) to identify the connectivity leg. The UE 22 knows from before that the SRB4 is established towards the first network node 16a. Hence, the UE 22 sends an indication to the first network node 16a that the data for the application session is carried via the second network node 16b, meaning that the second network node 16b should be receiving the RVQoE reports, which are carried from the UE 22 to the first network node 16a via SRB4.

Alternatively, the UE 22 may, together with the RVQoE report, send an indication to which node the report is aimed. This indication may always be sent, or only in certain circumstances, e.g., when the report is targeted for the other node, when the target node has changed since the last report, etc.
5. Based on the indication received from the UE 22 in step 4, the first network node 16a sends an indication to the second network node 16b, informing it that the RVQoE reports according to the second configuration pertain to the leg between the UE 22 and the second network node 16b.
   a. In one variant, the indication from the first to the second network node 16b may be a notification of the above (Indication A).
   b. In another variant, the indication may be a query (an interest poll) to the second network node 16b, about whether the second network node 16b is interested in receiving the RVQoE reports from the UE 22 via the first network node 16a (Indication B).
   c. In another variant, the indication may be a query “asking” the second network node 16b to provide the parameters for the RVQoE measurements at the UE 22 (Indication C).
   d. Any of the indications may contain a request to second network node 16b that the second network node 16b sets up SRB4 towards the UE 22.
   e. Note that the above does not depend on whether both first and second network node 16b are within the area scope of the first and the second configuration.
   f. Note that the above is valid also for the case when one of the nodes used for NR-DC (or MR-DC) connectivity and that configured the UE 22 for RVQOE, is later removed from the UE 22 configuration (for instance, the UE 22 is reconfigured from multi-connectivity to single connectivity, or the UE 22 is reconfigured with a different NR-DC (or MR-DC) configuration)
6. The second network node 16b responds to the indication received from the first network node 16a in step 5.
   a. In case second network node 16b received indication A, the second network node 16b may confirm the reception.
   b. In case second network node 16b received indication B, the second network node 16b may reply whether it is interested in receiving from the first network node 16a the RVQoE reports pertaining to the second configuration received from the UE 22.
      i. In case the second network node 16b is interested in receiving the RVQoE reports, it may also indicate to the first network node 16a whether it requests that the SRB4 is set up between the UE 22 and the second network node 16b instead of being set up between the first network node 16a and the UE 22.
      ii. In case the second network node 16b is not interested in receiving the RVQoE reports from the UE 22 via first network node 16a, the first network node 16a may deactivate the RVQoE measurements pertaining to the second configuration.
   c. In case second network node 16b received indication C, the second network node 16b may indicate the desired RVQoE configuration parameters.
7. Based on the response received from the second network node 16b in step 6, the first network node 16a takes one or more of the following actions (any meaningful combination of the below actions is possible):
   a. If the second network node 16b acknowledged the reception of indication A, the first network node 16a may, from now on, forward to the second network node 16b the RVQoE reports pertaining to the second configuration received from the UE 22. Alternatively, the first network node 16a may decide to request the second network node 16b to set up SRB4 towards the UE 22, and it may de-configure the SRB4 that currently exists between the first network node 16a and the UE 22. This means that, from now on, the RVQoE reports will be sent to the second network node 16b directly from the UE 22. In another variant, the first network node 16a may retain the SRB4 with the UE 22 but may instruct the UE 22 to send the RVQoE reports to the second network node 16b via an already established SRB, e.g., SRB3.
   b. If the second network node 16b, based on received indication B, replied that it is interested in receiving the RVQoE reports, the first network node 16a may perform one or more of the actions described in point a. of this step (step 7).
   c. In case second network node 16b, based on received indication C, replied with a desired RVQoE measurement configuration that is different than the current second configuration, the first network node 16a may modify the second configuration accordingly.

The RVQoE reports may be delivered to the second network node 16b based on the actions performed in at least one of steps 1-7.

### Second Example Solution: Network-Based Solution

The second solution may include at least one of the following steps:
1. Same as in (or similar to) the first solution.
2. Same as in (or similar to) the first solution.
3. Same as in (or similar to) the first solution.

Henceforth, it may be assumed the first network node 16a has configured the UE 22 with QoE and RVQoE measurements and established SRB4 (and/or another SRB where the UE 22 may send RVQoE reports) towards the UE 22. This is a non-limiting example, e.g., because it may be the case that, instead, the second network node 16b has configured the first and second configuration to the UE 22. At this point, neither of the two nodes are aware which of them carries the data for the application session for the first service.
4. The first network node 16a receives from the UE 22 the RVQoE reports pertaining to the second configuration. The RVQoE reports may contain the DRB ID and/or QoS flow ID and/or PDU session ID of the application session subject to the RVQOE measurement. As the content of the RVQoE reports is visible to the first network node 16a, based on the service type to which the RVQoE measurement refers to, DRB ID and/or QoS flow ID and/or PDU session ID therein, the first network node 16a realizes that the data for the application session subject to the RVQoE measurement is delivered to the UE 22 via the second network node 16b. For example, the first network node 16a may infer based on the DRB ID in the RVQoE report that the session is carried via the second network node 16b, since, as part of DC setup procedure, the MN indicates to the SN what are the available DRB IDs to be used by the SN for SCG terminated DRBs, ensuring the uniqueness of DRB IDs set up towards a UE 22 in DC. Instead, or in combination with this, the method described in section “How a UE identifies the leg carrying application data flow(s),” where the application includes socket information in the RVQoE report that may be used to identify the connectivity leg. Hence, the first network node 16a realizes that the second network node 16b should be receiving the RVQoE reports, which are carried from the UE 22 to the first network node 16a via SRB4.

Alternatively, the UE 22 may, together with the RVQoE report, send an indication to which node the report is aimed. This indication may always be sent, or only in certain circumstances, e.g., when the report is targeted for the other node, when the target node has changed since the last report etc.
a. In one option, the first network node 16a can determine that data for the application session subject to the RVQOE measurement is delivered to the UE 22 entirely via the second network node 16b by using one or more of the following indications: service type, DRB ID, QoS flow ID, PDU Session ID associated to the application session, timestamps received within or together with the RVQoE reports, indications (or absence of indication) indicating no user plane activity for the UE 22 with the first network node 16a for the time period to which the RVQoE report refers to.
b. The first network node 16a can further determine (e.g., based on timestamps sent within or together with the RVQoE reports and indications collected at the first network node 16a indicating a user plane activity for the UE 22 with the first network node 16a), that data for the application session subject to the RVQoE measurements was partly delivered to the UE 22 via the first network node 16a, and retain the RVQoE measurements for optimization at the first network node 16a.
5. Same as in (or similar to) the first solution.
6. Same as in (or similar to) the first solution.
7. Same as in (or similar to) the first solution.
8. Same as in (or similar to) the first solution.

In one embodiment, the first network node 16a and the second network node 16b can agree—before any RVQoE configuration is issued to any UE 22—the sending of RVQOE measurements received from the UE 22 to the node that configured the UE 22 for RVQOE. This coordination can be achieved e.g., during the execution of one of the procedures related to multi-connectivity operation where the UE 22 is reconfigured from single connectivity to multi-connectivity (e.g., Secondary Node Addition). The UE 22 may be reconfigured from a first configuration in multi-connectivity to a second configuration in multi-connectivity (e.g., Secondary Node Modification-MN initiated or SN initiated, Secondary Node Change-MN initiated or SN initiated, Inter-MN handover with/without SN change). The node interested to receive RVQoE report (e.g., the MN) can signals to the other node (e.g., the SN) a flag to indicate a request for obtaining RVQoE reports a UE 22 may send to the other node (the request could be generic, i.e., applicable to any RVQoE reports, or more granular, e.g., indicating that MN is interested to receive RVQoE reports only for a specific service).

In another embodiment, the first network node 16a (second network node 16b) may have agreed—before any RVQoE configuration is issued to any UE 22—with the second network node 16b (first network node 16a) to send to the second network node 16b (first network node 16a) RVQoE measurements pertaining to data delivered to the UE 22 via the first network node 16a (second network node 16b). This may be performed for the case when both the first network node 16a and second network node 16b are used in NR-DC (or any other form of MR-DC), provided that the second network node 16b hosts (or is connected to) an AI/ML training function for which RVQoE measurements are used as input data and has requested to receive such RVQoE measurements.

### How a UE Identifies the Leg Carrying Application Data Flow(s)

To determine which connectivity leg (towards the MN or towards the SN) the data flows subject to RVQoE measurements are carried on, the UE 22 may rely on inherent knowledge in the application.

An application creates network sockets for its application data flows and a socket may have several associated parameters, which may be used to identify the socket and the application data flow(s) that goes through it. These parameters may include at least one of:
Local IP address (i.e., the source IP address for outgoing data flows and the destination IP address for incoming data flows)
Remote IP address (i.e., the source IP address for incoming data flows and the destination IP address for outgoing data flows)
Local transport protocol port (i.e., the source transport protocol port for outgoing data flows and the destination transport protocol port for incoming data flows)
Remote transport protocol port (i.e., the source transport protocol port for incoming data flows and the destination transport protocol port for outgoing data flows)
Transport protocol (e.g., transport control protocol (TCP), stream control transfer protocol (SCTP), real time protocol (RTP))

Of the above, the local IP address is potentially known also by the UE AS, since it is the IP address assigned to the UE 22.

To enable the UE AS to identify DRB(s) and connectivity leg carrying certain application data flow(s), the application (in the UE application layer) informs the UE 22 AS of all or a subset of the above listed socket parameters (e.g., optionally excluding the local IP address) of each incoming and outgoing data flow. The UE AS can use this information (henceforth referred to as socket information) to check which DRB(s)—and connectivity leg—the packets matching this information are sent and received on.

The socket information from the UE application layer may be transferred on request from the UE AS, either as a one-time request (e.g., upon receiving an RVQoE report from the UE application layer), or as a more general request (e.g., when the RVQoE configuration is sent to the UE application layer or when a session start indication is received from the UE application layer). Such a more general request would make the application send the socket information at the start of each application session that is subject to RVQoE measurements (and send updated information during the session if the information changes). Alternatively, the application could, as a result of a general request from the UE AS, send socket information to the UE AS every time the application creates a socket. As another alternative, such a more general request would make the application send the socket information together with each RVQoE report.

Another option would be that instead of relying on a request from the UE AS, it would be indicated in the RVQoE configuration that the application should send this information to the UE AS at the start of each application session (with updates during the session if needed), upon socket creation, and/or together with each RVQoE report.

Yet another possible option could be to completely bypass the UE AS and instead let the application (at the UE application layer) include the socket information in the RVQoE report (governed by the RVQoE configuration), and then it would be up to the RAN node receiving the RVQoE report to determine which DRB(s) (and thus which connectivity leg) the application data flow(s) is (are) carried on.

For the communication of socket information between the application and the UE AS, AT commands, AT command responses and/or unsolicited result codes (which are part of the AT command framework) may be used.

### ADDITIONAL CONSIDERATIONS

3GPP specs allow that a UE 22 may establish only one SRB of a certain type, and this was the assumption taken in the invention. However, the solutions presented herein are also applicable if the UE 22 was allowed to set SRB4 towards both the first and the second network nodes 16a, 16b. In this case, there may be no need for the first network node 16a to request the second network node 16b to set up SRB4, as the SRB4 may already be set up between the UE 22 and both nodes. In this case:
The first network node 16a may indicate to the second network node 16b that the RVQoE reports pertaining to the second configuration will be, from now on, delivered from the UE 22 directly to the second network node 16b via SRB4.
Upon realizing that data for the session subject to RVQoE measurements is delivered to the UE 22 via the second network node 16b (Solution 2), or upon receiving such an indication from the UE 22 (Solution 1), the first network node 16a may instruct the UE 22 to send the RVQoE reports pertaining to the second configuration directly to the second network node 16b.
   Alternatively, the UE 22 may on its own decide to send the RVQoE reports to the second network node 16b directly and may notify the first network node 16a about it.

### CG-Config

A message is used to transfer the SCG radio configuration as generated by the SgNB or SeNB. It can also be used by a CU to request a DU to perform certain actions, e.g., to request the DU to perform a new lower layer configuration.

Direction: Secondary gNB or eNB to master gNB or eNB, alternatively CU to DU.

A nonlimiting example of a CG-Config message is as follows:

-- ASN1START
-- TAG-CG-CONFIG-INFO-START

| | |
|---|---|
| CG-ConfigInfo ::= | SEQUENCE { |
| criticalExtensions | CHOICE { |
| c1 | CHOICE{ |
| cg-ConfigInfo | CG-ConfigInfo-IEs, |

```
      spare3 NULL, spare2 NULL, spare1 NULL
    },
```

| | |
|---|---|
| criticalExtensionsFuture | SEQUENCE { } |

}
}

| | |
|---|---|
| CG-ConfigInfo-IEs ::= | SEQUENCE { |
| ue-CapabilityInfo | OCTET STRING (CONTAINING UE-CapabilityRAT- |
| ContainerList) | OPTIONAL,-- Cond SN-AddMod |
| candidateCellInfoListMN | MeasResultList2NR |

OPTIONAL,

| | |
|---|---|
| candidateCellInfoListSN | OCTET STRING (CONTAINING MeasResultList2NR) |

OPTIONAL,

| | |
|---|---|
| measResultCellListSFTD-NR | MeasResultCellListSFTD-NR |

OPTIONAL,

| | |
|---|---|
| scgFailureInfo | SEQUENCE { |
| failureType | ENUMERATED { t310-Expiry, randomAccessProblem, |
| | rlc-MaxNumRetx, synchReconfigFailure-SCG, |
| | scg-reconfigFailure, |
| | srb3-IntegrityFailure}, |
| measResultSCG | OCTET STRING (CONTAINING MeasResultSCG- |
| Failure) | |

| | |
|---|---|
| } | OPTIONAL, |

| | |
|---|---|
| configRestrictInfo | ConfigRestrictInfoSCG |

OPTIONAL,

| | | |
|---|---|---|
| drx-InfoMCG | DRX-Info | OPTIONAL, |

| | |
|---|---|
| measConfigMN | MeasConfigMN |

OPTIONAL,

| | |
|---|---|
| sourceConfigSCG | OCTET STRING (CONTAINING RRCReconfiguration) |

OPTIONAL,

| | |
|---|---|
| scg-RB-Config | OCTET STRING (CONTAINING RadioBearerConfig) |

OPTIONAL,

| | |
|---|---|
| mcg-RB-Config | OCTET STRING (CONTAINING RadioBearerConfig) |

OPTIONAL,

| | |
|---|---|
| mrdc-AssistanceInfo | MRDC-AssistanceInfo |

OPTIONAL,

| | |
|---|---|
| nonCriticalExtension | CG-ConfigInfo-v1540-IEs |

OPTIONAL
}

| | |
|---|---|
| CG-ConfigInfo-v1700-IEs ::= | SEQUENCE { |
| candidateCellListCPC-r17 | CandidateCellListCPC-r17 |

OPTIONAL,

| | |
|---|---|
| twoPHRModeSCG-r17 | ENUMERATED {enabled} |

OPTIONAL,

| | |
|---|---|
| lowMobilityEvaluationConnectedInPCell-r17 | ENUMERATED {enabled} |

OPTIONAL,

A nonlimiting example of CG-ConfigInfo field descriptions is included in the following table:

TABLE 1
CG-ConfigInfo field descriptions.
CG-ConfigInfo field descriptions

rvQoEConfigured
This filed indicates the set of services in which the SN configured
the RAN Visible (RV) QoE measurements.
servicesRunningOverSCG
This filed indicates the set of services for which the data traffic is
transmitted by the SCG i.e., all the DRBs associated to this service
are configured/running/owned by SCG.
rvQoEreportsRequest
This filed indicates the set of services for which the SN is
interested to receive RV QoE reports from the MN.

### UE Capability Indication

The UE 22 may be configured to (e.g., may need) indicate to the network its capability of performing actions pertaining to the solutions described. As a part of UE capability signaling (an enhanced existing signaling or newly defined signaling), the UE 22 indicates to the network its capabilities to act according to embodiments of the present disclosure, i.e., to send to the network the indication of the node that carries the application session, to be configured with the mentioned SRB configurations, to forward the RVQoE reports directly to the appropriate network node, etc.

The following is a nonlimiting list of example embodiments:
Embodiment A1. A first network node configured to communicate with a user equipment, UE, and a second network node, at least the UE being configurable to communicate using multi-radio connectivity, the first network node being configured to, and/or comprising a radio interface and/or comprising processing circuitry configured to:
transmit information to the second network node about which one of the first and second network nodes has configured quality of experience measurements for a predetermined service type associated with the UE;
determine which one of the first and second network nodes carries data for an application session subject to the quality of experience measurements for the predetermined service type; and
forward a quality of experience report corresponding to the application session to the second network node when the second network node carries the data for the application session subject to the quality of experience measurements.
Embodiment A2. The first network node of Embodiment A1, wherein the processing circuitry is configured to:
cause the first network node to configure the UE to at least one of:
   transmit the quality of experience report to at least one of the first and second network nodes; and
   indicate to which one of the first and second network nodes the quality of experience is targeted.
Embodiment A3. The first network node of any one of Embodiments A1 and A2, wherein at least one of:
the first and second network nodes are radio access network, RAN, nodes;
the UE is configurable to transmit a capability indication to at least one of the first and second network nodes;
the quality of experience measurements are RAN visible quality of experience, RVQoE, measurements; and
the quality of experience report is an RVQoE report.
Embodiment B1. A method in a first network node configured to communicate with a user equipment, UE, and a second network node, at least the UE being configurable to communicate using multi-radio connectivity, the method comprising:
transmitting information to the second network node about which one of the first and second network nodes has configured quality of experience measurements for a predetermined service type associated with the UE;
determining which one of the first and second network nodes carries data for an application session subject to the quality of experience measurements for the predetermined service type; and
forwarding a quality of experience report corresponding to the application session to the second network node when the second network node carries the data for the application session subject to quality of experience measurements.
Embodiment B2. The method of Embodiment B1, wherein the method further includes:
configuring the UE to at least one of:
   transmit the quality of experience report to at least one of the first and second network nodes; and
   indicate to which one of the first and second network nodes the quality of experience is targeted.
Embodiment B3. The method of any one of Embodiments B1 and B2, wherein at least one of:
the first and second network nodes are radio access network, RAN, nodes;
the UE is configurable to transmit a capability indication to at least one of the first and second network nodes;
the quality of experience measurements are RAN visible quality of experience, RVQoE, measurements; and
the quality of experience report is an RVQoE report.
Embodiment C1. A user equipment, UE, configured to communicate with a first network node and a second network node, at least the UE being configurable to communicate using multi-radio connectivity, the UE configured to, and/or comprising a radio interface and/or processing circuitry configured to:
determine that data for an application session subject to quality of experience measurements for a predetermined service type associated with the UE is carried by the second network node; and
transmit an indication at least to the first network node, the indication indicating that the data for the application session subject to the quality of experience measurements for the predetermined service type is carried by the second network node, the indication being usable by the first network node to forward, to the second network node, a quality of experience report corresponding to the application session.
Embodiment C2. The UE of Embodiment C1, wherein the UE is configured by at least one of the first and second network nodes to:
transmit the quality of experience report to at least one of the first and second network nodes.
Embodiment C3. The UE of any one of Embodiments C1 and C2, wherein at least one of:
the first and second network nodes are radio access network, RAN, nodes;
the UE is configurable to transmit a capability indication to at least one of the first and second network nodes;
the quality of experience measurements are RAN visible quality of experience, RVQoE, measurements; and
the quality of experience report is an RVQoE report.
Embodiment D1. A method in a user equipment, UE, configured to communicate with a first network node and a second network node, at least the UE being configurable to communicate using multi-radio connectivity, the method comprising:
determining that data for an application session subject to quality of experience measurements for a predetermined service type associated with the UE is carried by the second network node; and
transmitting an indication at least to the first network node, the indication indicating that the data for the application session subject to the quality of experience measurements for the predetermined service type is carried by the second network node, the indication being usable by the first network node to forward, to the second network node, a quality of experience report corresponding to the application session.
Embodiment D2. The method of Embodiment D1, wherein the UE is configured by at least one of the first and second network nodes to:
transmit the quality of experience report to at least one of the first and second network nodes.
Embodiment D3. The method of any one of Embodiments D1 and D2, wherein at least one of:
the first and second network nodes are radio access network, RAN, nodes;
the UE is configurable to transmit a capability indication to at least one of the first and second network nodes;
the quality of experience measurements are RAN visible quality of experience,
RVQoE, measurements; and
the quality of experience report is an RVQoE report.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G 5th Generation
5GC 5G Core network
5GS 5th Generation System
AS Access Stratum
AMF Access and Mobility Management Function
ASN.1 Abstract Syntax Notation One
AT Attention
AR Augmented Reality
AS Access Stratum
BAP Backhaul Adaptation Protocol
CGI Cell Global Identity
CN Core Network
CP Control Plane
CU Central Unit
CU-CP Central Unit Control Plane
CU-UP Central Unit User Plane
DU Distributed Unit
DASH Dynamic Adaptive Streaming over HTTP
DC Dual Connectivity
DL Downlink
DNS Domain Name System
E-CGI
E-UTRAN CGI: eNB Evolved Node B/E-UTRAN Node Ben-gNB. A gNB acting as a secondary node in an EN-DC scenario (i.e., in a DC scenario with an eNB as the master node and a gNB as the secondary node.
EN E-UTRAN-NR
EPC Evolved Packet Core
EPS Evolved Packet System
E-UTRA Evolved UTRA
E-UTRAN/
EUTRAN Evolved UTRAN
gNB Radio base station in NR
HSS Home Subscriber Server
HTTP Hypertext Transfer Protocol
IAB Integrated Access and Backhaul
ID Identifier/Identity
IE Information Element
LTE Long Term Evolution
MAC Medium Access Control
MCC Mobile Country Code
MCE Measurement Collection Entity/Measurement Collector Entity
MDT Minimization of Drive Tests
MME Mobility Management Entity
MN Master Node
MNC Mobile Network Code
MTSI Multimedia Telephony Service for IMS
N3IWF Non-3GPP Interworking Function
NG Next Generation
NG The interface between an NG-RAN and a 5GC.
NGAP NG Application Protocol
NG-RAN NG Radio Access Network
NID Network identifier
NR New Radio
NWDAF Network Data Analytics Function
O&M Operation and Maintenance
OAM Operation and Maintenance
PDCP Packet Data Convergence Protocol
PDU Protocol Data Unit
PLMN Public Land Mobile Network
QMC QoE Measurement Collection
QoE Quality of Experience
QoS Quality of Service
RAN Radio Access Network
RAT Radio Access Technology
RLC Radio Link Control
RNC Radio Network Controller
RRC Radio Resource Control
RVQOE RAN Visible QoE
S1 The interface between the RAN and the CN in LTE.
S1AP S1 Application Protocol
S-NSSAI Single Network Slice Selection Assistance Information
SMO Service Management and Orchestration
SN Secondary Node
SRB Signaling Radio Bearer
TA Tracking Area
TCE Trace Collection Entity/Trace Collector Entity
TNGF Trusted Non-3GPP Gateway Function
TWIF Trusted WLAN Interworking Function
UDM Unified Data Management
UE User Equipment
UMTS Universal Mobile Telecommunication System
URI Uniform Resource Identifier
URL Uniform Resource Locator Uniform Resource Locator
UTRA Universal Terrestrial Radio Access
UTRAN Universal Terrestrial Radio Access Network
WLAN Wireless Local Area Network
Xn The interface between two gNBs in NR.
XnAP Xn Application Protocol

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a first network node configured to communicate with a user equipment, UE, and a second network node, at least the UE being configurable to communicate using multi-radio connectivity with the first network node and the second network node, the method comprising:
coordinating with the second network node to determine which one of the first network node and the second network node has a report corresponding to a service type associated with the UE;
determining which one of the first network node and the second network node carries data for an application session subject to quality of experience measurements associated with the report; and
performing one or more actions to ensure that one of the first network node and the second network node which carries the data obtains the report.

2. The method of claim 1, wherein the coordination includes one of:
transmitting to the second network node a first indication indicating that the first network node has received the report from the UE; and
receiving from the second network node a second indication indicating that the second network node has received the report from the UE.

3. The method of claim 1, wherein:
the report comprises one or more of a data radio bearer, DRB, identifier, ID, a quality of service, QoS, flow ID, and a packet data unit, PDU, session ID; and
the determining which one of the first network node and the second network node carries the data for the application session is based on one or more of the DRB ID, the QoS flow ID, and the PDU session ID.

4. The method of claim 1, wherein the method further includes:
receiving the report from the UE.

5. The method of claim 4, wherein performing the one or more actions includes:
transmitting the report to the second network node when the second network node carries the data for the application session, the transmitted report being usable by the second network node to one or both of transmit to and receive from the UE signaling associated with the service type.

6. The method of claim 1, wherein performing the one or more actions includes:
receiving the report from the second network node when the first network node carries the data for the application session, the received report being usable by the first network node to one or both of transmit to and receive from the UE signaling associated with the service type.

7. (canceled)

11. A first network node configured to communicate with a user equipment, UE, and a second network node, at least the UE being configurable to communicate using multi-radio connectivity with the first network node and the second network node, the first network node being configured to:
coordinate with the second network node to determine which one of the first network node and the second network node has a report corresponding to a service type associated with the UE;
determine which one of the first network node and the second network node carries data for an application session subject to quality of experience measurements associated with the report; and
perform one or more actions to ensure that one of the first network node and the second network node which carries the data obtains the report.

12. The first network node of claim 11, wherein the coordination includes one of:
transmitting to the second network node a first indication indicating that the first network node has received the report from the UE; and
receiving from the second network node a second indication indicating that the second network node (16b) has received the report from the UE.

13. The first network node of claim 11, wherein:
the report comprises one or more of a data radio bearer, DRB, identifier, ID, a quality of service, QoS, flow ID, and a packet data unit, PDU, session ID; and
the determining which one of the first network node and the second network node carries the data for the application session is based on one or more of the DRB ID, the QoS flow ID, and the PDU session ID.

14. The first network node of claim 11, wherein the first network node is further configured to:
receive the report from the UE.

15. The first network node of claim 14, wherein performing the one or more actions includes:
transmitting the report to the second network node when the second network node carries the data for the application session, the transmitted report being usable by the second network node to one or both of transmit to and receive from the UE signaling associated with the service type.

16. The first network node of claim 11, wherein performing the one or more actions includes:
receiving the report from the second network node when the first network node carries the data for the application session, the received report being usable by the first network node to one or both of transmit to and receive from the UE signaling associated with the service type.

17. (canceled)

21. A method in a user equipment, UE, configured to communicate using multi-radio connectivity with a first network node and a second network node, the method comprising:
transmitting, to one of the first network node and the second network node, a report corresponding to a service type associated with the UE, the report comprising one or more of a data radio bearer, DRB, identifier, ID, a quality of service, QoS, flow ID, and a packet data unit, PDU, session ID, which one of the first network node and the second network node carries data for an application session being determined based on one or more of the DRB ID, the QoS flow ID, and the PDU session ID.

22. The method of claim 21, wherein the method further includes:
determining a capability indication usable by one or both of the first network node and the second network node to determine which one of the first network node and the second network node carries the data for the application session subject to quality of experience measurements associated with the report and perform one or more actions to ensure that one of the first network node and the second network node which carries the data obtains the report; and
transmitting the capability indication to one or both of the first network node and the second network node.

23. The method of claim 22, wherein when the report is transmitted to the first network node, the one or more actions includes:
transmitting, by the first network node, the report to the second network node when the second network node carries the data for the application session, the transmitted report being usable by the second network node to one or both of transmit to and receive from the UE signaling associated with the service type.

24. The method of claim 22, wherein the one or more actions includes:
receiving, by the first network node, the report from the second network node when the first network node carries the data for the application session, the received report being usable by the first network node to one or both of transmit to and receive from the UE signaling associated with the service type.

25. The method of claim 22, wherein the quality of experience measurements are one or both of quality of experience measurements, QoE, measurements, and radio access network, RAN, visible quality of experience, RVQoE, measurements.

26. (canceled)

31. A user equipment, UE, configured to communicate using multi-radio connectivity with a first network node and a second network node, the UE being configured to:
cause transmission, to one of the first network node and the second network node, of a report corresponding to a service type associated with the UE, the report comprising one or more of a data radio bearer, DRB, identifier, ID, a quality of service, QoS, flow ID, and a packet data unit, PDU, session ID, which one of the first network node and the second network node carries data for an application session being determined based on one or more of the DRB ID, the QoS flow ID, and the PDU session ID.

32. The UE of claim 31, wherein the UE is further configured to:
determine a capability indication usable by one or both of the first network node and the second network node to determine which one of the first network node and the second network node carries the data for the application session subject to quality of experience measurements associated with the report and perform one or more actions to ensure that one of the first network node and the second network node which carries the data obtains the report; and
cause transmission of the capability indication to one or both of the first network node and the second network node.

33. The UE of claim 32, wherein when the report is transmitted to the first network node, the one or more actions includes:
transmitting, by the first network node, the report to the second network node when the second network node carries the data for the application session, the transmitted report being usable by the second network node to one or both of transmit to and receive from the UE signaling associated with the service type.

34.-42. (canceled)
